(19) United States
(12) Patent Application Publication
(10) Pub. No.: US 2016/0362566 A1
(43) Pub. Date: Dec. 15, 2016

(54) ELECTRIC WIRE PROTECTIVE MATERIAL COMPOSITION, ELECTRIC WIRE PROTECTIVE MATERIAL, AND WIRE HARNESS

(71) Applicants: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP)

(72) Inventors: Toru SHIMIZU, Yokkaichi, Mie (JP); Seigou NAKANO, Yokkaichi, Mie (JP); Tatsuya SHIMADA, Yokkaichi, Mie (JP); Satoshi MURAO, Yokkaichi, Mie (JP)

(21) Appl. No.: 15/121,417

(22) PCT Filed: Feb. 6, 2015
(86) PCT No.: PCT/JP2015/053327

§ 371 Date: Aug. 25, 2016

(30) Foreign Application Priority Data
Feb. 26, 2014 (JP) 2014035582

(51) Int. Cl. C09D 7/12; H01B 7/00; H01B 3/44; C09D 123/12

(52) U.S. Cl. CPC C09D 7/1233; C09D 123/12; C09D 7/1241; H01B 7/0045; H01B 3/441; C08K 5/24

(57) ABSTRACT

A composition for an electric wire protective material is provided which, as a formed article, has good long-term heat resistance; also provided are an electric wire protective material and a wire harness. This composition for an electric wire protective material contains a polypropylene resin and a copper deactivator and is used to form the electric wire protective material. The composition for an electric wire protective material is configured using a compound with a molecular weight of 400 or greater as the copper deactivator, and said composition can be used to obtain the electric wire protective material by being formed into a prescribed shape which can protect an electric wire. The wire harness is configured in that the periphery of an electric wire bundle comprising multiple insulated electric wires bundled together is covered with the wire protective material formed using the aforementioned composition for an electric wire protective material.

### CROSS REFERENCE TO RELATED APPLICATIONS

This application claims the priority of Japanese patent application JP2014-035582 filed on Feb. 26, 2014, the entire contents of which are incorporated herein.

### TECHNICAL FIELD

The present invention relates to an electric wire protective material for protecting an electric wire bundle, such as a corrugated tube used for e.g. components of vehicles such as automobiles, components of electric/electronic equipments, and the like, an electric wire protective material composition which is used for the electric wire protective material, and a wire harness using the electric wire protective material.

### BACKGROUND ART

As a protective material for automotive electric wire, a corrugated tube or the like is used. A corrugated tube which is formed by using a polyolefin resin composition prepared by adding a copper inhibitor to polypropylene resin is conventionally known. (see e.g. Patent Document 1).

The above-mentioned Patent Document 1 (JP H10-173386A) describes that an oxalic acid derivative, a salicylic acid derivative and a hydrazine derivative are used as copper inhibitors to be added to the polyolefin resin composition. In Examples on a resin composition in Patent Document 1, Example 1 describes that 3-(N-salicyloyl)amino-1,2,4-triazol was used as a copper inhibitor, and Example 2 describes that ADK STAB ZS-27 produced by ADEKA CORPORATION was used.

### SUMMARY OF THE INVENTION

When the corrugated tube is used as an electric wire protective material, its deterioration due to contact with a copper wire and a copper braided wire housed inside can be prevented by adding a copper inhibitor.

When the corrugated tube is attached on a vehicle, a Grommet rubber may be brought into contact with the periphery of the corrugated tube for water stop. In this state, there was a problem that when the corrugated tube was exposed to a high temperature, the copper inhibitor in the corrugated tube migrated to the Grommet, and a content of the copper inhibitor in the corrugated tube was decreased. When the amount of the copper inhibitor added in the corrugated tube is decreased, the effects of the added copper inhibitor is lowered, and thus deterioration of the corrugated tube is enhanced, resulting in lowered long-term heat resistance.

The present design was made in view of the above-mentioned circumstances, and an object is to provide an electric wire protective material composition, an electric wire protective material and a wire harness, which allow preventing the copper inhibitor from migrating from the electric wire protective material like a corrugated tube to a member like a rubber in contact with the electric wire protective material and preventing deterioration of the electric wire protective material in a high-temperature state.

In order to solve the above problems, the electric wire protective material composition is characterized mainly in that it is a resin composition which contains a polypropylene resin and a copper deactivator and is used for forming an electric wire protective material, and that the copper deactivator is a compound with a molecular weight of 400 or more.

In the electric wire protective material composition, preferably the copper deactivator is a compound having an alkyl or alkylene group with two or more carbon atoms.

In the electric wire protective material composition, preferably the copper deactivator is a hydrazine compound.

In the electric wire protective material composition, preferably a flame retarder is further added.

In the electric wire protective material composition, preferably an antioxidant is further added.

In the electric wire protective material composition, preferably a phosphorus heat stabilizer is further added.

The electric wire protective material is characterized mainly in that it is made by forming an electric wire into a predetermined protectable shape by using the electric wire protective material composition.

The wire harness is characterized mainly in that the periphery of the electric wire bundle composed of bundled plural insulation electric wires is covered with the electric wire protective material formed using the electric wire protective material composition.

The electric wire protective material composition is a resin composition which contains a polypropylene resin and a copper deactivator and is used for forming an electric wire protective material, the copper deactivator is a compound having a molecular weight of 400 or more, thus, when the electric wire protective material is exposed to a high temperature, the migration of the copper deactivator to the rubber or the like due to heating becomes sluggish because the copper deactivator has a higher molecular weight than that of the conventional electric wire protective material composition using the copper deactivator with a molecular weight of less than 400, and thereby the migration of the copper deactivator to a Grommet rubber or the like in contact with the electric wire protective material can be suppressed. As a result, an effect of preventing enhancement of high temperature degradation in the electric wire protective material can be exhibited, and an effect of improving the long-term heat resistance of the electric wire protective material can be obtained.

Since the electric wire protective material of the present invention is made by forming an electric wire into a prescribed protectable shape by using the electric wire protective material composition, the material is excellent in the long-term heat resistance.

A wire harness having an excellent long-term heat resistance can be obtained by employing a constitution in which a periphery of an electric wire bundle composed of bundled plural insulation electric wires is coated with an electric wire protective material made of the electric wire protective material composition.

### DESCRIPTION OF EMBODIMENTS

Hereinafter, embodiments of the present invention will be explained in detail. The electric wire protective material composition is an example of an electric wire protective material composition used for forming an automotive corrugated tube containing a flame retardant. The electric wire protective material composition can be composed of e.g. the following (A)-(E) components. In the present invention, the composition contains at least the (A) polypropylene resin and the (B) copper deactivator.

The (A) polypropylene resin is used as a resin component, and the (B) copper deactivator, (C) frame retarder, (D) antioxidant and (E) phosphorus heat stabilizer, etc. are used as additive components. For the (C) frame retarder, a (C-1) bromine flame retardant, a (C-2) antimony trioxide, etc. are used in combination.

Hereinafter, each component in the electric wire protective material composition will be explained. The (A) polypropylene resin may be any of a block polypropylene and a random polypropylene. Additionally, as for the molecular structure, the polypropylene may be any of a syndiotactic polypropylene, an isotactic polypropylene and an atactic polypropylene.

For the electric wire protective material composition, a resin other than the polypropylene resin may be added as a resin component. Specifically the additive resin may include polyethylene, chlorinated polyethylene, ethylene-propylene rubber, various elastomers, etc.

Examples of the polyethylene may include high density polyethylene (HDPE), medium density polyethylene (MDPE), low density polyethylene (LDPE), linear low density polyethylene (LLDPE), very low density polyethylene (VLDPE) and metallocene ultralow density polyethylene, etc. These may be used alone or in combination.

For the additive resin, its type, addition amount and the like may be optionally selected in consideration of easiness of mix of the resin and the additives. The compounding ratio of the additive resin is preferably less than 50 mass % of the resin components.

The (B) copper deactivator is used to prevent the polypropylene resin from deteriorating when the electric wire protective material comes into contact with copper, for improving the heat aging resistance of the electric wire protective material. The copper deactivator is a so-called copper inhibitor. For the copper deactivator, one having a molecular weight of 400 or more is used. 3-(N-salicyloyl)amino-1,2,4-triazole described in Patent Document 1 or the like which has been conventionally used as a copper deactivator has a molecular weight of 204. The copper deactivator has a molecular weight of 400 or more. By using the relatively higher-molecular weight copper deactivator, the copper deactivator becomes hard to migrate in the electric wire protective material when the electric wire protective material formed from the resin composition becomes hot by heating, so that migration of the copper deactivator to the rubber or the like in contact with the electric wire protective material could be suppressed. As a result, an effect of preventing the deterioration due to copper damage of the electric wire protective material can be exhibited, and thereby it is possible to improve the long-term heat resistance.

Preferably, the copper deactivator with a molecular weight of 400 or more is, but not particularly limited to, a hydrazine compound. The copper deactivator with a molecular weight of 400 or more may include N′1,N′12-bis(2-hydroxybenzoyl)dodecane dihydrazide (molecular weight: 498), N,N′-bis[3-(3,5-di-tert-butyl-4-hydroxyphenyl)propionyl]hydrazine (molecular weight: 553), 3,9-bis(2,6-di-tert-butyl-4-methylphenoxy)-2,4,8,10-tetraoxa-3,9-diphosphaspiro[5,5]undecane (molecular weight: 633), diethylenetriamine pentaacetic acid sodium salt (molecular weight: 503), ethylenediamine tetraacetic acid potassium salt (molecular weight: 407), 1,4,7,10-tetraazacyclododecane-1,4,7,10-tetraacetic acid (DOTA) (molecular weight: 404) and the like.

As the copper deactivator, one having an alkyl or alkylene group having two or more carbon atoms in its molecule is preferred. The copper deactivator having such an alkyl or alkylene group may include e.g. N′1,N′12-bis(2-hydroxybenzoyl)dodecane dihydrazide, N,N′-bis[3-(3,5-di-tert-butyl-4-hydroxyphenyl)propionyl]hydrazine and the like.

Preferably the compounding ratio of the (B) copper deactivator is, but not particularly limited to, within a range of 0.1 to 3 parts by mass relative to the resin components of 100 parts by mass. When the compounding ratio of the copper deactivator is less than 0.1 part by mass, the copper deactivating effect may be insufficient, and when it is more than 3 parts by mass, the copper deactivator may be precipitated on a die during extrusion forming, resulting in a gum.

For the (C) frame retarder, only one of the (C-1) bromine flame retardant or the (C-2) antimony trioxide may be added, but their combination is preferred. In relation to the typical compounding ratio of the (C-1) bromine flame retardant and the (C-2) antimony trioxide, bromine flame retardant:antimony trioxide=1:4 to 4:1 by mass ratio is typically preferable in light of an addition efficiency.

In relation to the compounding ratio of the flame retarder, a total amount of the bromine flame retardant and antimony trioxide is preferably within a range of 1.5 to 15 parts by mass relative to the resin components of 100 parts by mass. When the compounding ratio of the flame retarder is less than 1.5 parts by mass, the flame retardance may be insufficient, and when it is more than 15 parts by mass, the heat aging resistance may be lowered.

Although the (C-1) bromine flame retardant is not particularly limited, the bromine flame retardant may include e.g. tetrabromobisphenol A (TBA), decabromodiphenyl oxide, hexabromocyclododecane, octabromodiphenyl oxide, bistribromophenoxyethane, tribromophenol, ethylene bistetrabromophthalimide, TBA polycarbonate oligomer, brominated polystyrene, TBA epoxyoligomer polymer, ethylene bispentabromodiphenyl, hexabromobenzene, polydibromostyrene oxide, tetrabromodiphenyl oxide, etc. One of these flame retardants may be used alone, or two or more of them may be used in combination.

In relation to the bromine flame retardant, one having a melting point of 110° C. or higher is preferred. The bromine flame retardant having the melting point of 110° C. or higher may include e.g. ethylene bis(pentabromodiphenyl) (melting point: 350° C.), ethylene bistetrabromophthalimide (melting point: 456° C.), TBBA-bis(2,3-dibromopropyl ether) (melting point: 117° C.), etc.

Instead of the bromine flame retardant, a chlorine flame retardant such as perchlorocyclopentadecane, chlorinated paraffin, tetrachlorophthalic anhydride and chlorendic acid may be used.

As a flame retardant aid, the (C-2) antimony trioxide is used in combination with the bromine flame retardant. For antimony trioxide, a fine particle prepared by e.g. pulverizing antimony trioxide yielded as a mineral may be used. Combination of antimony trioxide with the bromine flame retardant can decrease the amount of the used bromine flame retardant.

Although the (D) antioxidant is not particularly limited, a phenol antioxidant is preferably used. As the phenol antioxidant, hindered phenol-based, monophenol-based, diphenol-based, triphenol-based and polyphenol-based antioxidants, etc. can be used. Among them, the hindered phenol antioxidant is preferred.

The hindered phenol antioxidant may include pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, N,N′-hexane-1,6-diylbis[3-(3,5-di-tert-butyl-4-hydroxyphenylpropionamide), benzenepropanoic acid, 3,5-bis(1,1-dimethylethyl)-4-hydroxy, C7-C9 side chain alkyl ester,2,4-dimethyl-6-(1-methylpentadecyl)phenol, diethyl[[3,5-bis(1,1-dimethylethyl)-4-hydroxyphenyl]methyl]phosphonate, 3,3′,3″,5,5′5″-hexa-tert-butyl-a,a′,a″-(mesitylene-2,4,6-triyl)tri-p-cresol, calcium diethyl bis[[[3,5-bis(1,1-dimethylethyl)-4-hydroxyphenyl]methyl]phosphonate], 4,6-bis(octylthiomethyl)-o-cresol, ethylene bis(oxyethylene)bis[3-(5-tert-butyl-4-hydroxy-m-tolyl)propionate], hexamethylene bis[3-(3,5-di-tert-butyl-4-hydroxyphenyl)propionate, 1,3,5-tris(3,5-di-tert-butyl-4-hydroxybenzyl)-1,3,5-triazine-2,4,6-(1H, 3H, 5H)-trione, 1,3,5-tris[(4-tert-butyl-3-hydroxy-2,6-xylyl)methyl]-1,3,5-triazine-2,4,6(1H, 3H, 5H)-trione, 2,6-tert-butyl-4-(4,6-bis(octylthio)-1,3,5-triazine-2-ylamino)phenol, 2,6-di-tert-butyl-4-methylphenol, 2,2′-methylenebis(4-methyl-6-tert-butylphenol), 4,4′-butylidenebis(3-methyl-6-tert-butylphenol), 4,4′-thiobis(3-methyl-6-tert-butylphenol), 3,9-bis[2-3-(3-tert-butyl-4-hydroxy-5-methylphenyl)-propinoxy)-1,1-dimethylethyl]-2,4,8,10-tetraoxaspiro(5,5) undecane, and the like. One of these antioxidants may be used alone, or two or more of them may be used in combination.

Preferably, the compounding ratio of the (D) antioxidant is, but not particularly limited to, within a range of 0.1 to 3 parts by mass relative to the resin components of 100 parts by mass. When the compounding ratio of the antioxidant is less than 0.1 part by mass, its addition effect may be insufficient, and when it is more than 3 parts by mass, the antioxidant may be precipitated on a die during extrusion forming, resulting in a gum.

The (E) phosphorus heat stabilizer is a processing heat stabilizer and is preferably used in combination with the phenol antioxidant. The phosphorus heat stabilizer may include diphenylnonylphenyl phosphite, tris-tridecyl phosphite, tris(2,4-di-tert-butylphenyl)phosphite, etc.

Preferably, the compounding ratio of the (E) phosphorus heat stabilizer is, but not particularly limited to, within a range of 0.1 to 3 parts by mass relative to the resin components of 100 parts by mass. When the compounding ratio of the phosphorus heat stabilizer is less than 0.1 part by mass, its addition effect may be insufficient, and when it is more than 3 parts by mass, the additive may be precipitated on a die during extrusion forming, resulting in a gum.

In relation to the compounding ratio of the phenol antioxidant and the phosphorus heat stabilizer, phenol antioxidant:phosphorus heat stabilizer=1:5 to 5:1 is preferable. The compounding ratio can be arbitrarily selected according to a kind of the resin, a processing condition, etc.

The electric wire protective material composition may contain components other than the above-mentioned components unless the effects of the present invention is damaged. Specifically, these components may include additives such as fillers, colorants, antistatic agents, lubricants and nucleating agents. For the additives, known materials to be added to this kind of polypropylene resin composition can be used.

As the filler, e.g. metal oxides etc. can be used. The metal oxide may include e.g. zinc oxide, aluminum oxide, magnesium oxide, tin oxide, etc.

In addition, for the electric wire protective material composition, an inorganic flame retardant such as magnesium hydroxide and aluminum hydroxide may be used as a flame retardant.

For preparing the electric wire protective material composition, the above-mentioned each components should be mixed by a known mixing methods. An order of blending, a mixing method, etc. during mixing are not particularly limited. Specific mixing method may include e.g. mixing methods and the like using a usually-used mixer such as a tumbler-type blender, a V-shaped blender, a Henschel mixer, a ribbon mixer, an extruder (single-shaft, two-shaft), a Banbury mixer, a pressure kneader and a roller.

The electric wire protective material is formed into a predetermined shape capable of protecting the electric wire by using the electric wire protective material composition. One example of the electric wire protective material is a corrugated tube. The shape of the electric wire protecting member is not limited to the corrugated tube, and the shape has only to play a role in covering the periphery of the electric wire bundle and protecting the inside electric wire bundle from the outside environment or the like, and to allow protection of the electric wires or the electric wire bundle.

For manufacture of the corrugated tube, e.g. a polyolefin resin composition is extruded as a tubular product and then formed into an accordion-shaped corrugated tube by a mold. For extrusion of the tubular product, the electric wire protective material composition is melted at about 180-250° C., and continuously extruded into a tubular shape from a die of a forming nozzle.

In the wire harness, the periphery of the wire bundle composed of the bundled plural insulation electric wires is coated with the electric wire protective material formed with the electric wire protective material composition.

As the electric wire bundle to be used for the wire harness, a single electric wire bundle in which only insulation electric wires are bundled altogether, or a mixed electric wire bundle in which insulation electric wires and other insulation electric wires are mixedly bundled altogether can be used. The numbers of the electric wires contained in the single electric wire bundle and the mixed electric wire bundle are not particularly limited.

The electric wire protective material and the wire harness using the electric wire protective material composition with the above-mentioned shape can be preferably used as an automotive electric wire protective material and an automotive wire harness requiring long-term heat resistance. Particularly, the electric wire protective material is attached to a main body of a vehicle, while the rubber like grommet as a waterproof material contacts the outer peripheral surface. As the rubber, an EPDM rubber or the like is used, and is optimal for improving the long-term heat resistance when attached in contact with such a grommet.

### Examples

Hereinafter, Examples and Comparative Example of the present invention will be explained. Noted that the present invention is not limited by these Examples.

### Material Under Test, Manufacturer, Etc.

Materials under test used in Examples and Comparative Example will be explained with manufacturers, trade names, etc.
(A) Resin component: polypropylene

Block PP, Prime Polymer Co., Ltd., trade name “J356HP”
(B) Copper inhibitor (copper deactivator)
(B-1)

N′1,N′12-bis(2-hydroxybenzoyl)dodecanedihydrazide, ADEKA CORPORATION, trade name “ADK STAB CDA-6” (molecular weight: 498)
(B-2)

N,N′-bis[3-(3,5-di-tert-butyl-4-hydroxyphenyl) propionyl]hydrazine, ADEKA CORPORATION, trade name “ADK STAB CDA-10” (molecular weight: 553)
(B-3)

2-hydroxy-N-1H-1,2,4-triazol-3-ylbenzamide, ADEKA CORPORATION, trade name “ADK STAB CDA-1” (molecular weight: 204)
(C) Frame retarder
(C-1) Bromine flame retardant

Bis[3,5-dibromo propoxyphenyl)]sulfone, Marubishi Oil Chemical Co., Ltd., trade name “NonNen PR2”, melting point: 40-60° C.
(C-2) Antimony trioxide, NIHON SEIKO CO. LTD., trade name “PATOX-CF”
(D) Phenole antioxidant: BASF SE, trade name “IRGANOX1010”
(E) Phosphorus heat stabilizer: BASF SE, trade name “IRGAFOS168”

Hereinafter, the evaluation test methods for Examples and Comparative Example will be explained. Respective components of Examples and Comparative Example shown in Table 1 were mixed by a two-shaft kneader at a kneading temperature of 220° C., and then pelletized by a pelletizer to obtain pellets of each composition related to Examples and Comparative Example. Subsequently, each obtained pellet was used to form a corrugated tube, and this was subjected to an evaluation test for long-term heat resistance. The forming method and the evaluation test method are as follows.

### Corrugated Tube Forming Method

For the corrugated tube, a corrugated tube with an inner diameter of 10 mm was formed into a 200 mm long tube by blow extrusion forming while the temperature of the resin was 220° C.

### Test Method for Long-Term Heat Resistance

The electric wires and braided wires were passed through the formed corrugated tube, the both ends of the corrugated tube were sealed with the EPDM rubber, the tube was heated at 150° C. for 150 hours, and then the presence of cracks on the corrugated tube was observed. A case with no crack was defined as good (∘), and a case with crack was defined as poor (x).

TABLE 1

| | | | Comparative |
|---|---|---|---|
| Component Composition | Examples | | Example |
| (Unit: mass %) | 1 | 2 | 1 |
| (A) Polypropylene (Block PP) | 96.2 | 96.2 | 96.2 |
| (B) Copper inhibitor | | | |
| (B-1) ADK STAB CDA-6 (MW: 498) | 0.3 | — | — |
| (B-2) ADK STAB CDA-10 (MW: 553) | — | 0.3 | — |
| (B-3) ADK STAB CDA-1 (MW: 204) | — | — | 0.3 |
| (C) Frame retarder | | | |
| (C-1) Bromine flame retardant (NonNen | 2.0 | 2.0 | 2.0 |
| PR2) | | | |
| (C-2)Antimony trioxide | 1.0 | 1.0 | 1.0 |
| (D) Antioxidant (Irganox 1010) | 0.4 | 0.4 | 0.4 |
| (E) Phosphorus heat stabilizer (Irgafos 168) | 0.1 | 0.1 | 0.1 |
| Test results | | | |
| Long-term heat resistance (heated at 150° C. | ∘ | ∘ | x |
| for 150 hours) | | | |

As shown in Table 1, since the copper deactivator with a molecular weight of 400 or more was used in Examples 1 and 2, the compositions with a good long-term heat resistance was obtained. In contrast, since the copper deactivator with a molecular weight of less than 400 was used in Comparative Example 1, the long-term heat resistance was poor.

As described above, the embodiment of the present invention has been explained in detail, but the present invention is not limited to the above embodiment at all, and can be varied without departing from the scope of the present invention.

1. An electric wire protective material which is made by forming an electric wire into a predetermined protectable shape by using an electric wire protective material composition containing a polypropylene resin and a copper deactivator, wherein the copper deactivator is a compound having a molecular weight of 400 or more.

2. The electric wire protective material according to claim 1, wherein a Grommet rubber is in contact with an outer periphery.

3. The electric wire protective material according to claim 2, wherein migration of the copper deactivator to the Grommet rubber in contact with the outer periphery is prevented by the molecular weight of the copper deactivator being 400 or more.

4. The electric wire protective material according to claim 1, wherein the copper deactivator is a compound having an alkyl or alkylene group with two or more carbon atoms.

5. The electric wire protective material according to claim 1, wherein the copper deactivator is a hydrazine compound.

6. The electric wire protective material according to claim 1, wherein a frame retarder is further added.

7. An electric wire protective material according to claim 1, wherein an antioxidant is further added.

8. The electric wire protective material according to claim 1, wherein a phosphorus heat stabilizer is further added.

9. A wire harness, wherein a periphery of an electric wire bundle composed of bundled plural insulation electric wires is covered with the electric wire protective material in claim 1.
